(19) United States
(12) Patent Application Publication
(10) Pub. No.: US 2005/0278631 A1
(43) Pub. Date: Dec. 15, 2005

(54) Information recording/playback apparatus

(75) Inventor: Hiroyuki Kamio, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/136,445

(22) Filed: May 25, 2005

(30) Foreign Application Priority Data
Jun. 8, 2004 (JP) 2004-170430

(51) Int. Cl. G06F 7/00

(52) U.S. Cl. 715/704

(57) ABSTRACT

An information recording/playback apparatus, for example, sets the first and second object files and a single management file, stores the first object from the first encoder to the first object file, stores the second object from the second encoder to the second object file, and stores the first management information and second management information which manage the first and second objects in the single management file.

### CROSS-REFERENCE TO RELATED APPLICATIONS

This application is based upon and claims the benefit of priority from prior Japanese Patent Application No. 2004-170430, filed Jun. 8, 2004, the entire contents of which are incorporated herein by reference.

### BACKGROUND OF THE INVENTION

1. Field of the Invention

The present invention relates to an information recording/playback apparatus. For example, this information recording/playback apparatus has two encoders, records outputs from these encoders on an information recording medium (hard disk and/or DVD), and plays back information from this information recording medium. The present invention also relates to an information recording medium on which information is recorded by the information recording/playback apparatus.

2. Description of the Related Art

In recent years, TV broadcast has entered the era of digital broadcasts having Hi-Vision programs (programs of high-definition AV information) as principal broadcast contents. The current BS digital TV broadcast (and soon-to-be-available terrestrial digital TV broadcast) adopts an MPEG2 transport stream (to be abbreviated as MPEG-TS as needed hereinafter). In the field of digital broadcast using moving pictures, MPEG-TS will be used as a standard format in the future.

In Jpn. Pat. Appln. KOKAI Publication Nos. 2002-84479 and 2003-224813, a recording/playback apparatus which uses an optical disk such as a DVD-RAM is proposed.

For example, in this recording/playback apparatus, when two tuners receive broadcasting signals at the same time, input video signals corresponding to these broadcasting signals are often required to be recorded.

However, there is no effective means for recording, on the recording medium, the input video signals simultaneously sent from the plurality of tuners.

### BRIEF SUMMARY OF THE INVENTION

In an aspect of the present invention, an information recording/playback apparatus sets first and second object files and a single management file, stores a first object output from a first encoder into the first object file, stores a second object file output from a second encoder into the second object file, and stores a first management information for managing the first object and a second management information for managing the second object into the single management file. The information recording/playback apparatus also sets in the first object information the first file identification information which indicates that the first object is stored in the first object file, and sets in the second object information the second file identification information which indicates that the second object is stored in the second object file.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the entire arrangement of a recording/playback apparatus of the present invention;

FIG. 2 is a view showing the arrangement of a directory in a DVD format to which the recording/playback apparatus of the present invention is applied;

FIG. 3 is a view showing the arrangement of a management file in the DVD format to which the recording/playback apparatus of the present invention is applied;

FIG. 4 is a view showing the arrangement of M_AVFI in the DVD format to which the recording/playback apparatus of the present invention is applied;

FIG. 5 is a view showing the arrangement of M_VOBI in the DVD format to which the recording/playback apparatus of the present invention is applied;

FIG. 6 is a view showing the arrangement of TMAPI in the DVD format to which the recording/playback apparatus of the present invention is applied;

FIG. 7 is a view showing the arrangement of TM_ENT in the DVD format to which the recording/playback apparatus of the present invention is applied;

FIG. 8 is a view for explaining the example of a DVD format M_BOBI to which the recording/playback apparatus of the present invention is applied;

FIG. 9 is a view showing the example of an area assured on the information recording medium of the present invention;

FIG. 10 is a view showing the example of the area assured on the information recording medium of the present invention; and

FIG. 11 is a flowchart for explaining the example of a file management operation in the recording/playback apparatus of the present invention.

### DETAILED DESCRIPTION OF THE INVENTION

An embodiment of the present invention will be described below with reference to the accompanying drawing.

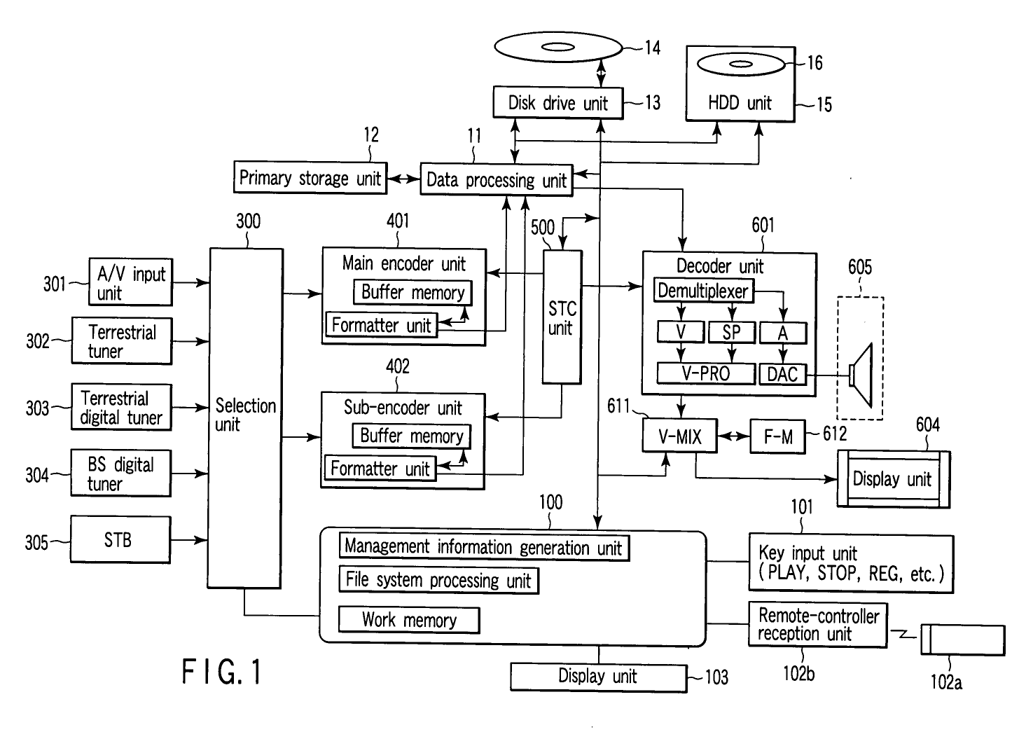

FIG. 1 is a block diagram showing the schematic arrangement of an information recording/playback apparatus according to an embodiment of the present invention. This information recording/playback apparatus records AV information (digital TV broadcast program or the like) on an information recording medium (optical disk, hard disk, or the like), and plays back the recorded AV information.

This apparatus has a microprocessing unit (MPU) 100, a key input unit 101, a remote-controller reception unit 102b for receiving user operation information from a remote controller 102a, and a display unit 103.

A selection unit 300 can receive signals from an audio-video input unit 301, terrestrial analog tuner 302, terrestrial digital tuner 303, BS digital tuner 304, and set-top box (STB) 305. The STB 305 is connected to a satellite antenna, decodes received digital broadcasting data, and outputs an AV signal (digital) obtained by the decoding process.

The selection unit 300 can also select an input stream, and supply the selected stream to a main encoder 401 and/or sub-encoder 402. The main encoder 401 and sub-encoder 402 convert the input signals into a predetermined format (for example, DVD standard or similar format), and supply their outputs to a data processing unit 11.

Each of the main encoder 401 and sub-encoder 402 includes an A/D converter, a video encoder unit, an input selector to the video encoder unit, an audio encoder unit, a sub-picture encoder unit, a formatter unit, and a buffer memory.

This apparatus has the main encoder unit 401 and sub-encoder unit 402 to simultaneously obtain two encoder outputs, and can record these encoder outputs on the information recording medium (an optical disk 14 or hard disk). This data processing technique will be described later in detail.

The analog signals from the terrestrial tuner 302 and A/V input unit 301 are converted into digital signals by an A/D converter. These digital signals are input to the respective encoders. A video signal is input to the video encoder unit, an audio signal is input to the audio encoder unit, and character data such as character broadcast is input to an SP encoder unit. The video signal is compressed by MPEG, the audio signal is compressed by AC3 or MPEG audio, and the character data is compressed by run length.

In each of the encoder units, the compressed data is converted into blocks to have 2,084 bytes per block, and these blocks are input to the formatter unit. The formatter unit multiplexes the input data, and sends the data to the data processing unit 11.

The data processing unit 11 forms one ECC block appended with error correction data for each of 16 (or 32) data blocks, and applies predetermined modulation to them. The modulated data is sent to a disk drive unit 13 and/or hard disk drive unit 15.

For example, when the disk drive unit 13 is busy due to seek, track jump, and the like, a primary storage unit 12 is used to wait a recording operation until the disk drive unit 13 is ready. The data processing unit 11 can time-divisionally send data to be recorded to the disk drive unit 13 and hard disk drive (HDD) 15 for respective recording data units (e.g., for respective CDA units as physical continuous recording units) under the control of the MPU 100.

Each of the encoder units 401 and 402 includes the formatter unit to send the recording data to the data processing unit 11. In addition to this, the formatter unit generates segmentation information, and periodically sends it to the MPU 100 (GOP head interrupt or the like). The segmentation information includes the number of LBs of a VOBU, the end address of an I-picture from the head of the VOBU, the playback time of the VOBU, and the like which are required for generating information that pertains to the following video object.

A system time counter (STC) 500 counts clocks on a 27-MHz basis. That is, this STC 500 generates reference clocks of respective units.

Data read from the optical disk 14 or a hard disk 16 upon playback undergoes amplification and error correction processes by the data processing unit 11, and is sent to a decoder unit 601. The decoder unit 601 includes a demultiplexer including a memory, a video decode unit including a reduced-scale image (thumbnail or the like) generation unit, a sub-picture (SP) decode unit, an audio decode unit, a video processor (V-PRO) unit, an audio D/A converter, and the like.

An analog output (monaural, stereo, or AAC 5.1CH surround) from the audio D/A converter is amplified by an AV amplifier or the like (not shown), and is input to a loudspeaker 605.

In order to display contents whose video recording is in progress, on a display unit 604 (e.g., TV), this apparatus can send stream data to be recorded to the decoder unit 601 simultaneously with the data processing unit 11, and play back the stream data to be recorded. In this case, the MPU 100 makes setups upon playback in the decoder unit 601 which then automatically executes a playback process.

The MPU 100 can also multiplex signals (e.g., on-screen display signal) such as character and symbol onto the output video signal from the decoder unit 601. In this multiplexing scheme, a video mixer 611 and frame memory 612 are used.

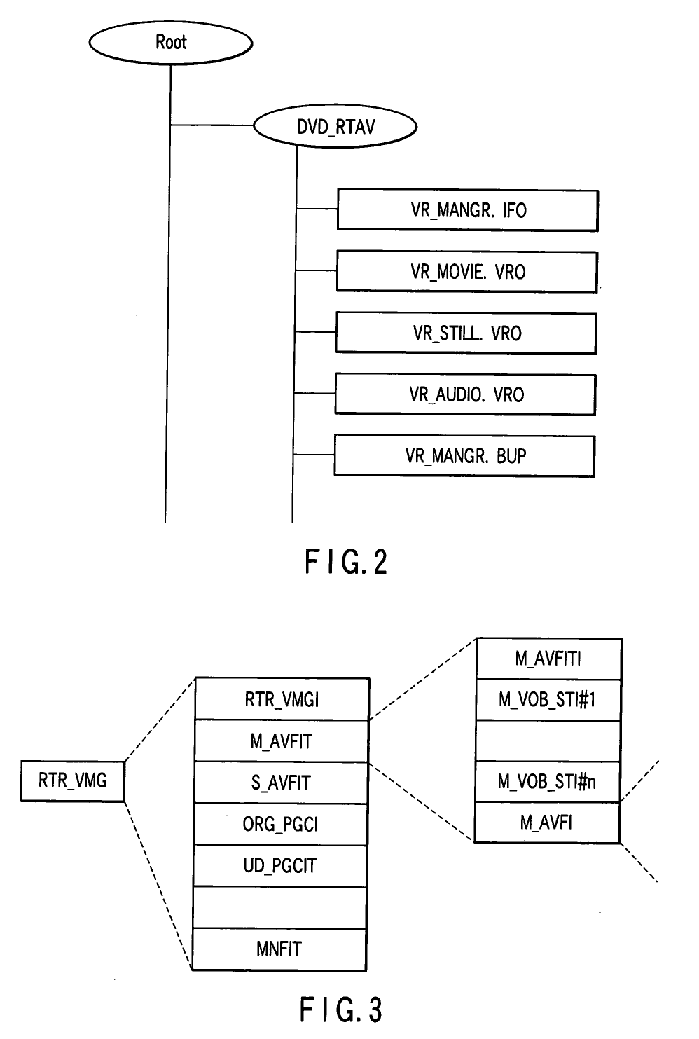

FIG. 2 shows the example of a root directory specified for a DVD-R, DVD-RAM, and DVD-RW on which video data can be recorded. In the root directory, the following files are specified, e.g., a management file VR_MANGR.IFO for management information, a content file VR_MOVIE.VRO for movie video, a content file VR_STILL.VRO for still video, a content file VR_MOVIE.VRO for audio, and a management file VR_MANGR.BUP for back-up management information. In addition to these, a file for computer information is also available. However, this file is omitted in this embodiment.

FIG. 3 shows a hierarchical structure of information described in the management file VR_MANGR.IFO. VR_MANGR.IFO includes a real time recording video manager (RTR_VMG). In RTR_VMG, real time recording video manager general information (RTR_VMGI), a movie AV file information table (M_AVFIT), a still file information table (S_AVFIT), original program chain information (ORG_PGCI), a user-defined program chain information table (UD_PGCIT), a manufacturer information table (MNFIT), and the like are set.

RTR_VMG is a group of navigation data used for controlling recording, playback, and editing of an AV stream (one or more VOBs).

RTR_VMGI describes the basic information of a real time recording disk. More specifically, RTR_VMGI includes information representing that RTR_VMGI is an RTR video manager file, the final address in RTR_VMG, the final address in RTR_VMGI, version information, resume mark information, disk representative image information, information for acquiring the description address in each information, and the like.

M_AVFIT will be further described below. S_AVFIT describes information about a still picture AV file.

ORG_PGCI is program chain information which is additionally generated for each recording of a program on the information recording medium, and represents the playback order of the program by a cell and time map.

UD_PGCIT is a chain information table which determines the playback order of contents when connecting the desired portions of the AV file already recorded by editing or the like. UD_PGCIT specifies the playback order of the contents by the time map (to be described later).

MNFIT is an area to be used by a manufacturer, and includes a manufacturer's ID, the information of time when the manufacturer inputs manufacturer's information, data arbitrary recorded by the manufacturer.

M_AVFIT includes movie AV file information table information (M_AVFITI), pieces of movie video object stream information (M_VOB_STI#1 to M_VOB STI#n), and movie AV file information (M_AVFI).

M_AVFIT describes information which pertains to the file VR_MOVIE.VRO. M_AVFITI includes the number of M_AVFIs, the number of M_VOB_STIs, and the final address in M_AVFIT. M_VOB_STI includes a video attribute, the number of audio streams, the number of sub-picture streams, the audio attributes of the respective streams, the color palette of sub-picture data, and the like.

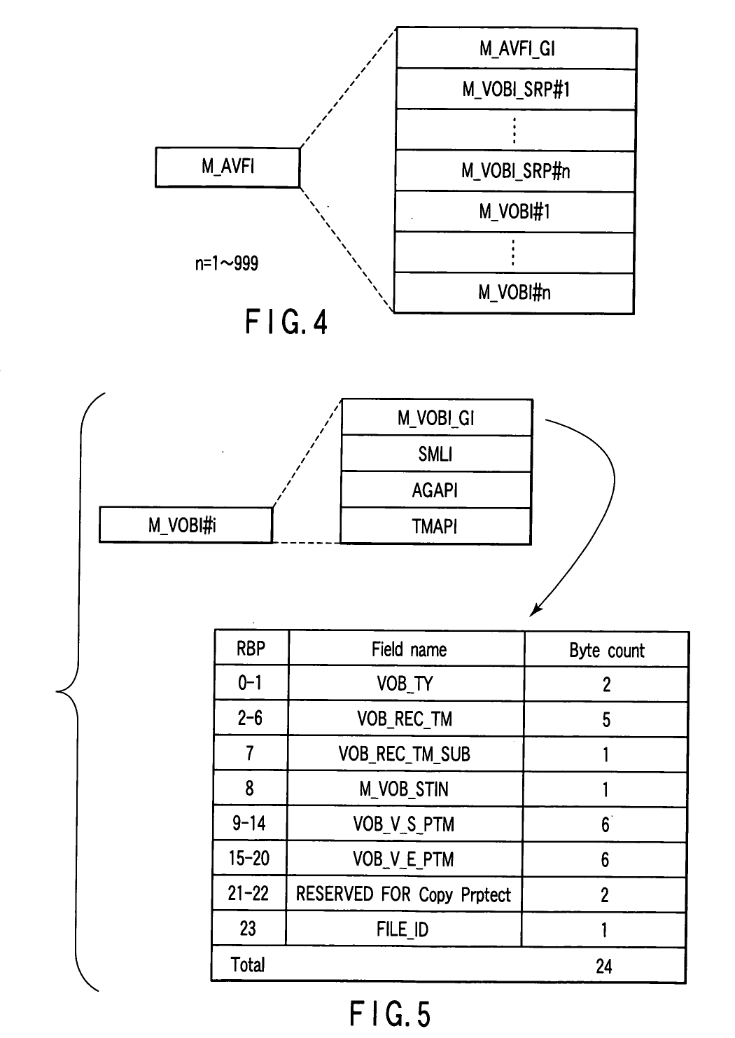

M_AVFI includes information which pertains to the movie file (file name: VR_MOVIE.VRO). As shown in FIG. 4, M_AVFI includes movie AV file information general information (M_AVFI_GI), movie video object search pointers (M_VOBI_SRP#1 to M_VOBI_SRP#n), and pieces of movie video object information (M_VOBI#1 to M_VOBI#n) where n=1 to 999. That is, the 1 to 999 video objects (VOBs) can be recorded and managed in the AV file.

M_VOBI_SRP#1 is a search pointer for searching for M_VOBI#1. M_VOBI_SRP#2 is a search pointer for searching for M_VOBI#2. M_VOBI_SRP#n is a search pointer for searching for M_VOBI#n.

FIG. 5 shows the contents of M_VOBI#i. M_VOBI#i includes movie video object general information (M_VOB_GI), seamless information (SMLI), audio gap information (AGAPI), and time map information (TMAPI).

M_VOB_GI describes VOB_TY to indicate if the VOB is normal or temporarily erased. M_VOB_GI also indicates if the VOB is played back seamlessly. VOB_REC_TM indicates the information of time when the head of the VOB is recorded. VOB_REC_TM also records sub-second data information.

Furthermore, the stream information number of this VOB (M_VOB_STIN), the playback start time of the first field in this VOB (M_V_S_PTM), the segmentation time of the last field in this VOB (M_V_E_PTM), and the like are described.

SMLI indicates system clock reference information for the VOB in order to seamlessly play back the VOB. That is, SMLI describes the pieces of time information of the first and last stream packs of the VOB. When the plurality of audio streams are indicated for this VOB, AGAPI describes the stop time of each of the audio streams, and the length of a gap.

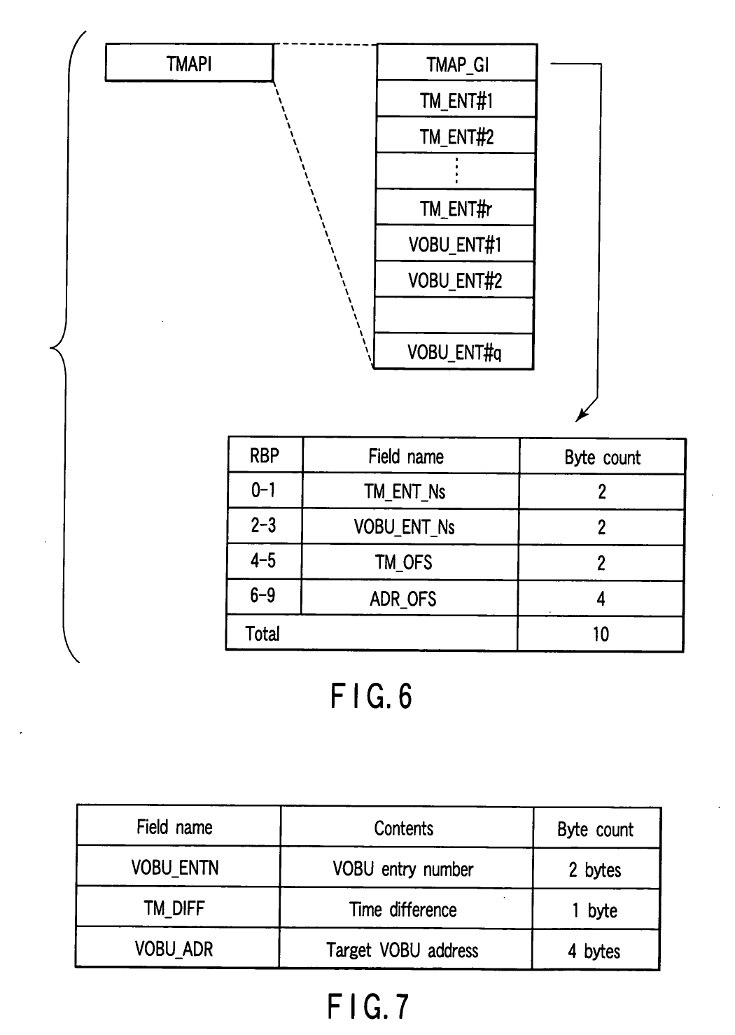

FIG. 6 shows the above-described time map information (TMAPI) in detail. TMAPI includes TMAP_G₁, TM_ENT#1 to TM_ENT#n, and VOBU_ENT#1 to VOBU_ENT#n. TMAP_GI includes TM_ENT_Ns, and indicates the number of described TM_ENTs. TMAP_GI also includes VOBU_ENT_Ns, and indicates the number of described VOBU_ENTs.

The VOB includes the one or more video object units (VOBUs) to manage the VOB for each VOBU.

TM_OFS describes a time offset for this time map in a video field. TM_OFS also sets ADR_OFS. ADR_OFS indicates the start address of this VOB. This start address indicates the position from the first logical block address in the video file. Therefore, even when the plurality of start positions of the VOBs shift from each other, the VOB and the next VOB can be connected and played back by using this start address.

FIG. 7 shows the contents of TM_ENT. TM_ENT includes the pieces of information of VOBU_ENTN, TM_DIFF, and VOBU_ADR.

VOBU_ENTN describes the entry number of the corresponding VOBU by a relative logical block number from the start in the VOB. TM_DIFF describes a difference between the presentation start time of the VOBU that is specified by this time entry, and the calculated presentation time, by using the relative logical block number from the start in the VOB. VOBU_ADR describes the first pack address in the VOBU serving as a target, by using the relative logical block number from the start in the VOB.

The above-described VOBU_ENT describes a picture size as the first reference of the VOBU. This size is represented by the number of packs in which the reference picture of the VOBU is stored. VOBU_ENT also describes VOBU_PB_TM, i.e., the playback time information of this VOBU, and the number of packs as the total size of the VOBU.

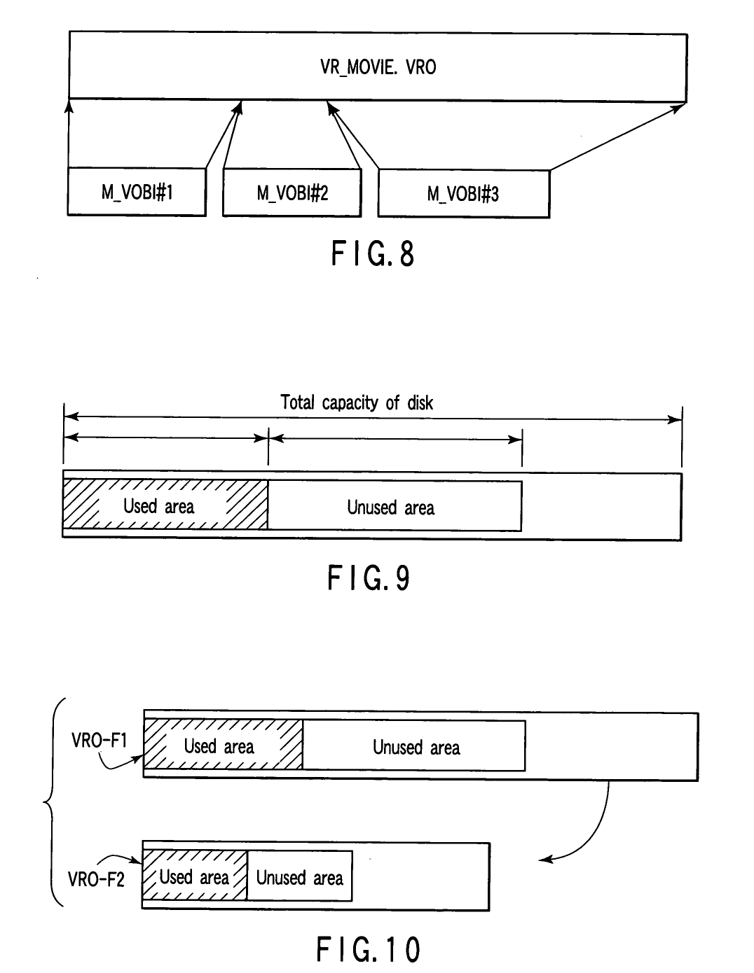

Referring to FIG. 8, the video file can be managed by the plurality of VOBIs (object information indicating the playback sequence). M_VOBI indicates a given segment in the VR_MOVIE.VRO file. Hence, in the present invention, the video object information (VOBI) is effectively used. For example, when programs such as a baseball game and drama are continuously recorded (continuously recorded for 2 or 1 hour), one VOBI (management information for a period from the start to end of recording) is generated.

This apparatus includes the main encoder unit 401 and sub-encoder unit 402. Hence, these encoders can process data corresponding to drama 1 and drama 2, respectively. When two encoded data are simultaneously output from these encoders, the MPU 100 generates two VOBIs corresponding to drama 1 and drama 2.

Alternatively, when an input video signal is compressed by MPEG2, and formatted into the pack of the DVD standard, the object is recorded on, e.g., the hard disk 16. On the hard disk 16, the first and second files are assured in correspondence with the first (main) and second (sub) encoder units 401 and 402. The outputs (objects) from the first and second encoder units 401 and 402 are stored in the first and second object files (the first and second VR_MOVIE.VROs) via the data processing unit 11. In contrast to this, a single file is set as the management file (VR_MANGR.IFO). The VOBI (management information) in this management file is then processed.

For example, as shown in FIG. 5, a file identification information (FILE_ID) area is assured. In this file identification information (FILE_ID) area, information for identifying which VRO file (the first or second VR_MOVIE.VRO) stores the object to be managed is stored.

Therefore, when playing back the VOBI, with reference to the file identification information, the object in the first file can be played back upon playing back the file corresponding to one identification information, and the object in the second file can be played back upon playing back the file corresponding to another identification information.

A file system in which the first and second VR_MOVIE.VROs, and the management file (VR_MANGR.IFO) are assured as described above will be described below.

In the DVD disk format, a concept of the file system which guarantees a UDF is specified. This file system is a generic concept in comparison with the above management, and manages the used and unused areas of the disk, the entry information recording areas of various files, a defective area, and the like. These recording areas are managed on the basis of the physical address, physical sector address, and logical block address of a disk. These recording areas are also used for assuring the unused area, by using the concept of “extent”.

FIG. 9 shows a state wherein a general recording area is assured on the DVD standard. In this state, the used and unused areas are assured in correspondence with the capacity of the entire disk. This standard defines that one storage file of the video object is used for each disk. Therefore, when starting recording, the video object is added in VR_MOVIE.VRO (called a VRO file). At this time, sequential recording unit as one program is managed by the above-described VOBI.

Note that, in the present invention, it is easy to generate two VRO files on the disk in advance, and these files undergo respective recording processes. Hence, a DVD recording format is individually extended. The information (FILE_ID) indicating which VRO file records the AV information (MPEG stream), i.e., the VOB is added to M_VOBI, and the information is stored in the management information file (VR_MANGR.IFO). With this operation, one management (IFO) file can manage the plurality of VRO files.

In the DVD standard, the file system which guarantees the UDF manages the file in the disk. In the file system, a free area in the disk is assigned to the file in addition to the area (called an extent) in which the contents are actually recorded. Hence, the free space can be assured.

Assume that the used area is called a contents extent, and the unused area is called a reserved extent.

Since this information recording/playback apparatus includes two encoders, the VRO files corresponding to these encoders are generated on the information recording medium. When recording the information, the information is written in these VRO files. The free capacity to be assigned to these files can be determined by adjusting the sizes of the reserved extents of the files.

For example, when the half capacity of the disk is assigned to one VRO file when initializing the disk, and the remaining capacity is assigned to another VRO file, the disk can be used by the two VRO files, equally.

However, if the disk is only halved, upon using one encoder, the VRO file loses the free capacity corresponding to this encoder, and only another encoder can be used. To solve this problem, a means for moving the reversed extent between two VRO files is available.

In FIG. 10, two VRO files (VRO-F1 and VRO-F2) are assured. The portion of the reserved extent of one VRO file (VRO-F1) shifts to another VRO file (VRO-F2). Accordingly, since the free area can be exchanged between these two files, the disk capacity can be effectively used. This means uses a control program for driving the file system, and is implemented in the MPU 100.

At the timing of changing the size of the contents extent in the VRO files, e.g., when ending recording or deleting the recorded data, this means can always keep the reserved extent size of one of the VRO files constant.

That is, when ending recording or deleting the recorded data, the file system resets the pieces of management information of the used and unused areas. The file system also adds (in initial recording) and deletes the file entry information. In addition to these, the file system modifies the file length information.

In the information recording/playback apparatus shown in FIG. 1, a capacity of 4.7 GB can be assigned to the VRO file for the sub-encoder, and all of the remaining capacity of the hard disk can be assigned to the VRO file for the main encoder. Hence, the capacity corresponding to one DVD-RAM can be assured for the sub-encoder. This management method is easily understood by the user.

However, when only the 5-GB free capacity remains in the hard disk, only the 0.3-GB capacity remains in the file for the main encoder if the 4.7-GB capacity is assigned to the sub-encoder.

Hence, in this case of the present invention, assume that the main encoder must be preferentially used on the basis of the difference between the characteristics of the main encoder and sub-encoder. For example, when the free capacity of the hard disk is less than double capacities of 4.7 GB, the entire free area is assigned to the main encoder file.

As the application of this reserved extent shifting process, the actually recorded contents extent can shift. Originally, the VRO file is not allowed to be divided into two segments in the DVD video recording format. Hence, the DVD video recording format can be observed by shifting the entire contents extent of the VRO file for sub-encoder when printing ends.

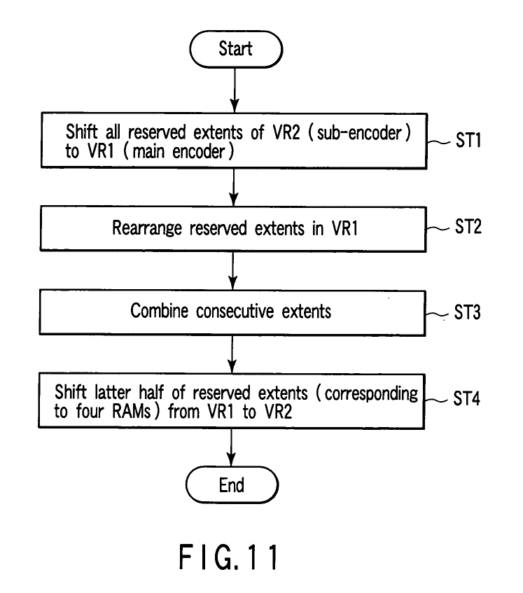

FIG. 11 shows the file management operation in the file system. The recording medium serves as the hard disk. First, when recording ends, the entire reserved extent managed for the sub-encoder shifts to the reserved extent managed for the main encoder (step ST1). The file system rearranges the files as the reserved extent for the main encoder (step ST2). This rearranging process is implemented in the file system. In this process, the used and unused areas are reset, and the defective area is set when the defective area is found. After that, the reserved extent is sequentially connected (step ST3). This process is implemented by describing an extent allocation in the unused area. In this process, a physical sector number (PSN; physical address assigned to the entire area of the disk), logical sector number (LSN; for each logical sector in the entire disk), and logical block number (LBN; for each logical block in the data area) on the disk are used.

Next, the reversed extents corresponding to the four RAMs of the reserved extents on the main encoder shift to the sub-encoder (step ST4). Accordingly, the file system for managing the file can manage the plurality of (e.g., two) VRO files on the hard disk 16 side. The file system can also manage the file IFO serving as the management information. In the file IFO, an extension (FILE_ID) is added to M_VOBI. Hence, the file system can control recording/playback of the respective pieces of AV information in two VRO files.

In the above description, the recording/playback medium serves as the hard disk, and the file system, two VRO files, and the file IFO are used in correspondence with the hard disk. The same process can also apply when the recording medium serves as the DVD 14.

It should be noted, however, that when the DVD 14 is extracted from the apparatus, the extension (FILE_ID) of above M_VOBI is not defined in the DVD standard.

Therefore, the information recording/playback apparatus of the present invention has a means for shifting the state where the above file system manages the two VRO files and the one file IFO, to the management state which is adapted to the DVD standard. The information recording/playback apparatus also has a means for shifting the state where the one file IFO controls recording/playback of the two VRO files, to the state where the one file IFO can control recording/playback of the two VRO files as the one VRO file.

A case where two VRO files are recorded on a DVD loaded into the information recording/playback apparatus, and the DVD is extracted from the information recording/playback apparatus will described below. In this case, recording includes a case wherein the two VRO files, one file IFO, and file system on the hard disk shift to the DVD.

The principle that only one VRO file is recorded on one disk must be maintained. The information recording/playback apparatus of the present invention has a means for modifying the file IFO such that recording/playback can be controlled by using the file serving as one VRO file obtained by connecting the first and second files of the main decoder and sub-encoder. This modification is changed to delete FILE_ID in M_VOBI by the MPU as shown in FIG. 5, or cause the MPU to ignore this FILE_ID. Next, an address offset generated on the sub-encoder side in M_VOBI is rewritten. As described above, since M_VOBI in the management file does not have a file identifier, and the address offset in M_VOBI on the sub-encoder side is rewritten, the object in the used area on the main encoder side becomes the first video object (VOB#1), and the object in the used area on the sub-encoder side becomes the second object (VOB#2). Accordingly, these two objects can be managed as one VRO file. Of course, in the time information described in the time map, the playback time described in the second VOBI is modified such that the time maps of the second object (VOB#2) is continuously connected to the value of the final playback time of the first video object (VOB#1).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information recording/playback apparatus comprising:
first means for setting a first object file, a second object file, and a single management file;
second means for setting a file system including entry information for accessing to the first object file, the second object file, and the single management file;
third means for converting a first input video signal and a second input video signal into a first object and a second object which correspond to predetermined formats, respectively; and
fourth means for setting, in the single management file, management information used to manage recording of the first object and the second object in the first object file and the second object file, and playback of the first object and the second object recorded in the first object file and the second object file, setting, in the management information, first object information which indicates a playback sequence of the first object stored in the first object file, setting, in the first object information, first file identification information which indicates that the first object is stored in the first object file, setting, in the management information, second object information which indicates a playback sequence of the second object stored in the second object file, and setting, in the second object information, second file identification information which indicates that the second object is stored in the second object file.

2. An apparatus according to claim 1, wherein
the first means sets the first object file, the second object file, and the single management file for a hard disk or an optical disk, and
the third means converts the first input video signal and the second input video signal into the first object and the second object which correspond to a DVD standard format.

3. An apparatus according to claim 2, further comprising
fifth means for deleting the first file identification information and the second file identification information which are set in the first object information and the second object information in order to combine the first object file and the second object file so as to regard the first object file and the second object file as one file, and correcting an address offset included in the second object information so as to continuously play back the second object after playing back the first object in accordance with the first object information.

4. An apparatus according to claim 3, further comprising
sixth means for recording, on a digital video disk, the management information including the second object information in which the address offset is corrected, and information included in the first object file and the second object file.

5. An information recording/playback apparatus comprises:
first means for assuring, by an extent, a first file area which is used to record information on a recording medium, and assuring a used area and an unused area in the first file area; and
second means for dividing a given portion from the unused area in the first file area, and assuring an unused area of a second file area.

6. An apparatus according to claim 5, wherein
the first means and the second means combine the unused area of the second file area with the unused area of the first file area when ending recording or deleting a program, reassuring the combined unused area as the unused area of the first file area, dividing a given portion from the unused area of the reassured first file area, and reassuring the unused area of the second file area.

7. An apparatus according to claim 6, further comprising
third means for stopping management of the unused area of the second file area when an total capacity of the recording medium is less than a predetermined value.

8. An information recording/playback apparatus comprises:
first means for assuring, by an extent, a first file area which is used to record information on a recording medium, and assuring a used area and an unused area in the first file area;
second means for dividing a given portion from the unused area in the first file area, and assuring an unused area of a second file area;
third means for adding an offset to an object address included in second management information which manages second contents, in order to integrally manage first contents recorded in the used area of the first file area and the second contents recorded in a used area of the second file area; and
fourth means for managing the second management information including the object address added with the offset, as a portion of first management information used to manage the first contents.
